(19) United States
(12) Patent Application Publication
(10) Pub. No.: US 2006/0179657 A1
(43) Pub. Date: Aug. 17, 2006

(54) Shaver with flushable hair chamber

(76) Inventors: Roger Gerard Elisabeth Van Der Linden, Drachten (NL); Adam Wessel Christoffel Deermann, Harkstede (NL); Bart Johannes Massee, Amersfoort (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,281

(22) PCT Filed: Jun. 24, 2004
(86) PCT No.: PCT/IB04/50990

§ 371 Date: Dec. 22, 2005

(30) Foreign Application Priority Data
Jun. 27, 2003 (EP) 03101919.3

(51) Int. Cl. B26B 19/38

(52) U.S. Cl. 30/41; 30/43.6

(57) ABSTRACT

A shaver has a shaving head holder (10) mounted to the housing (2), and movable between an operating position and a cleaning position. A hair chamber (13) is located between the shaving head holder (10) and housing portions which include a bottom (16) and side walls (17). The hair chamber (13) communicates with the environment via at least one flushing port (18) in at least one of said housing portions (16, 17) bounding the hair chamber (13). The flushing port (or ports) (18) has (have) an exit (19) at the outside of the housing (2).

This invention relates to a shaver having a shaving head or shaving heads with a shaving screen including hair-receiving openings and a driven cutter or driven cutters cooperating with the openings in the screen for cutting off hairs projecting through the hair-receiving openings. Behind the shaving head or heads, a hair chamber is located in which cut-off whiskers, hair dust and skin chips accumulate. If the hair chamber is not cleaned regularly, an unhygienic situation arises which impairs the function of the shaver and sometimes leads to malfunction of the shaver or even damage to the shaver. Such an accumulation can and should be avoided by regular cleaning of the hair chamber. Most shavers allow quite easy disassembling of some parts for gaining access to the hair chamber, such as a quick-release connection of the shaving head holder to the housing and retention means that hold various parts together when the hair chamber is open, and some shavers are waterproof so that the hair chamber can be flushed with water, for example water running from a tap. However, there is a desire to facilitate the cleaning of the hair chamber still further.

Various shavers are known from the prior art which include a fan for drawing air through the hair receiving openings. For example, Japanese patent application 01-97493 discloses a shaver with an impeller for moving air and hair from behind the shaving blade to a dust collecting part where air is exhausted via a filter, U.S. Pat. No. 3,634,935 discloses a shaver with a fan and a centrifugal separator downstream of the fan for separating hair from an airflow arriving from the shaving head, U.S. Pat. No. 3,828,430 discloses a shaver with nets in front of outlet openings to avoid that hair is blown out of the shaver, U.S. Pat. 4,031,618 discloses a shaver with a vacuum system for drawing hairs into a cutting position and exhausting cut hair from the casing, and U.S. Pat. No. 4,089,110 discloses a shaver with a receptacle communicating with an outlet passage for collecting the cut whiskers.

However, operation of such shavers is either cumbersome, because hair collecting receptacles and filters have to be emptied and cleaned regularly to avoid clogging up of shaving debris therein, or it soils the environment because whiskers and hair dust etc. are blown out of the housing over a relatively large area. Moreover, relatively much of the cut hair and skin is left back in the hair chamber.

It is an object of the invention to provide a solution for facilitating the cleaning of the hair chamber of a shaver.

According to the invention, this object is achieved by providing a shaver according to claim 1.

The flushing port or ports in at least one of the housing portions bounding the hair chamber facilitate the flushing of shaving debris away by facilitating the flow of water carrying along shaving debris through the hair chamber. Since the at least one flushing port in the housing portion bounding the chamber has its exit at the outside of the housing, a very short flushing port is obtained that allows water to flow into and from the hair chamber very easily.

Particular embodiments of the invention are set forth in the dependent claims. Further aspects, effects and details of the invention appear from the detailed description of an example of a shaver according to the invention shown in the drawings.

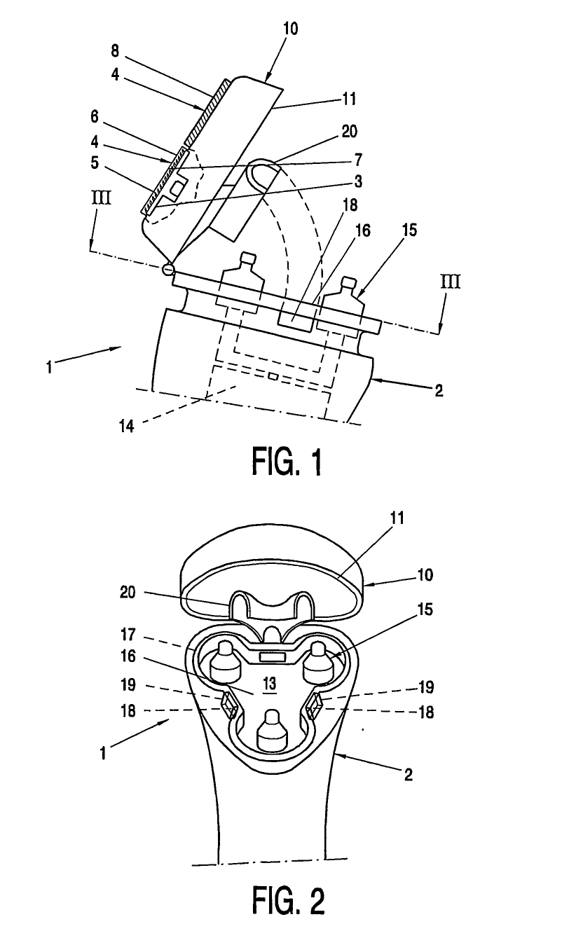

FIG. 1 is a partially cut-away side view of a top portion of a shaver according to the invention, with a shaving head holder in a cleaning position;

FIG. 2 is a frontal view of the shaver according to FIG. 1; and

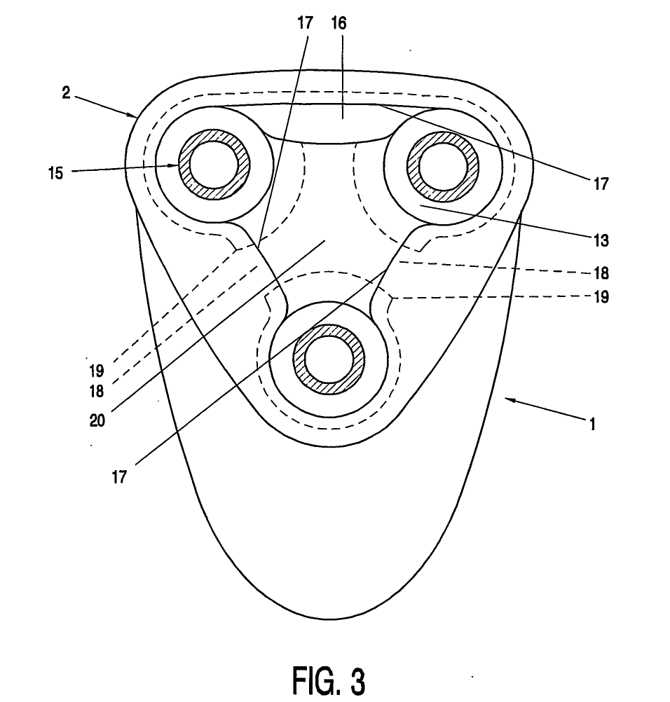

FIG. 3 is a view in cross-section taken on the line III-III in FIG. 1, but with the shaving head holder in an operating position.

FIGS. 1 to 3 show an example of a shaver 1 according to the invention. This shaver has a housing 2 in which a motorized drive structure 15 including a motor 14 (schematically depicted in FIG. 1) is accommodated. The drive structure is connected to three crown-shaped cutters 3 in respective shaving heads 4. The cutters 3 each have a plurality of cutting edges 5 that are each movable along an inner surface 7 of a screen 6 of the respective shaving head 4. The screen 6 has hair-receiving openings in the form of slits 8. In operation, stubble or other hairs projecting through the hair receiving openings 8 are cut off by the cutting edges 5 of the cutters 3 moving along the inner surfaces 7 of the screens 6 of the shaving heads 4.

The shaving heads 4 are suspended in a shaving head holder 10. The shaving head holder 10 is pivotable away from the housing 2 from an operating position against the housing 2 along an edge 11 of the shaving head holder 10 into an open, cleaning position (shown in FIGS. 1 and 2) pivoted away from the housing 2. When the shaving head holder 10 is in its operating position, it closes off a hair chamber 13, between, on one side, the shaving head holder 10 and, on the opposite side, the housing portions in the form of a bottom 16 and side walls 17. In its cleaning position, the shaving head holder 10 allows access to the hair chamber 13 for cleaning. It is observed that the shaving head holder 10 may also be suspended to the housing 2 in another manner than pivotably. The shaving head holder 10 may, for example, be mounted completely detachably. It is also possible to provide that the shaving head holder is not movable relative to the housing.

The housing 2 is waterproof or at least water resistant, so that at least the shaving head side of the shaver can be flushed with water, at least briefly without causing danger or damage to the shaver.

The hair chamber 13 communicates with the environment via flushing ports 18 in the side walls 17. The flushing ports 18 in the side walls 17 each have an exit 19 at the outside of the housing 2. The flushing ports 18 facilitate flushing by facilitating the flow of water carrying along shaving debris through the hair chamber 13. Since the flushing ports have their exits 19 at the outside of the housing 2, the ports 18 are very short, allowing water to flow into and from the hair chamber 13 very easily.

A closing member 20 is provided which is displaceable between a closing position (shown in FIG. 3) for closing off the flushing ports 18 and a flushing position (shown in FIGS. 1 and 2) for allowing water to pass through the flushing ports. Closing off of the flushing ports 18 provides the advantage that when the shaver is used shaving debris is prevented from falling out of the shaver through the flushing ports 18. This is particularly advantageous when the shaver is used as a dry shaver, i.e. without shaving lotion, in which case the shaving debris consists of very fine loose particles.

The closing member 20 is mounted to the shaving head holder 10 for displacement from the closed position when the shaving head holder 10 is in the operating position into the flushing position when the shaving head holder 10 is in the cleaning position, so that the flushing ports 18 are automatically opened when the shaving head holder 10 is moved away from its operating position.

The flushing ports 13 are mounted opposite each other, so water can be flushed straight through the hair chamber 13 or, if the water enters the hair chamber from the side that is open when the shaving head holder is in its cleaning position, in opposite directions. This is favorable for an effective entrainment of shaving debris by the water flushed through the hair chamber 13. For effective and powerful flushing, it is also advantageous if the flushing ports are relatively large, the cross-section of the flushing ports preferably having a smallest dimension of at least 3 mm and preferably of at least 4 mm.

It is observed that within the framework of the present invention many other embodiments are conceivable. For example, separate closing members may be provided for closing each flushing port or group of flushing ports. It is also possible to provide that the shaving head holder is not movable away from its operating position. The hair chamber is then flushed either in the absence of a closing member, or the closing member is displaceable away from the closed position without the shaving head holder moving away from the housing.

IN THE CLAIMS

1. A shaver comprising:
a housing (2); and
a shaving head holder (10) mounted to the housing (2) and carrying at least one shaving head (4) having an external surface for contacting a skin to be shaved and hair receiving openings (8), and at least one cutter (3) that is movable along the internal surface (7) of the screen (6), the at least one cutter (3) cooperating with the screen (6) for cutting off hairs projecting through the hair receiving openings (8, 9);
a hair chamber (13) located between the shaving head holder (10) and portions of the housing (2), said portions including a bottom (16) and side walls (17);
wherein the hair chamber (13) communicates with the environment via at least one flushing port (18) in at least one of said housing portions (16, 17) bounding the hair chamber (13), said at least one flushing port (18) having an exit (19) at the outside of said housing (2).

2. A shaver according to claim 1, further comprising at least one closing member (20) displaceable between a closing position for closing off the at least one flushing port (18) and a flushing position for allowing water to pass through the at least one flushing port (18).

3. A shaver according to claim 1, wherein the shaving head holder (10) is movable from an operating position, i.e. away from said housing portions (16, 17), for allowing access to the hair chamber (13) for cleaning.

4. A shaver according to claim 2, wherein the closing member (20) is mounted to the shaving head holder (10) for displacement from the closed position, in which the shaving head holder (10) is in the operating position, into the flushing position, in which the shaving head holder (10) is moved away from the operating position.

5. A shaver according to claim 1, wherein at least two of said flushing ports (13) are mounted opposite each other.
